(19) United States
(12) Patent Application Publication
(10) Pub. No.: US 2003/0022966 A1
(43) Pub. Date: Jan. 30, 2003

(54) Composites containing ABS

(76) Inventors: Edgar Leitz, Dormagen (DE); Harry Staratschek, Leverkusen (DE); Herbert Eichenauer, Dormagen (DE); Wolfgang Siebourg, Bonn (DE)

Correspondence Address: BAYER CORPORATION, PATENT DEPARTMENT, 100 BAYER ROAD, PITTSBURGH, PA, 15205, US

(21) Appl. No.: 10/161,878

(22) Filed: Jun. 4, 2002

(30) Foreign Application Priority Data
Jun. 7, 2001 (DE) 10127749.0

(51) Int. Cl. B32B 15/08; B32B 27/08; B32B 27/36; C08K 5/34; B32B 27/30; B32B 23/08

(52) U.S. Cl. 524/99; 428/412; 428/483; 428/462; 428/414; 428/416; 428/518; 428/520; 428/514; 428/476.3; 524/13

(57) ABSTRACT

A composite containing an ABS component is disclosed. Containing component (I) that includes A) an ABS polymer and B) a compound containing at least one sterically hindered amine group of the general formula

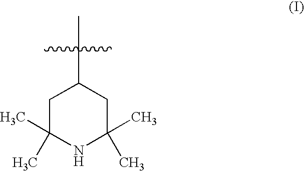

and component (II) that is an additional material selected from metals, woods and other plastics, the composite is suitable for preparing a variety of articles.

### FIELD OF THE INVENTION

The invention relates to composites and more particularly to composites containing an ABS component.

### SUMMARY OF THE INVENTION

A composite containing an ABS component is disclosed. Containing component (I) that includes A) an ABS polymer and B) a compound containing at least one sterically hindered amine group of the general formula

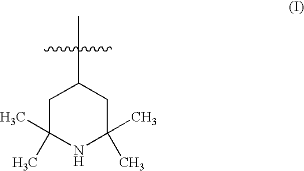

and component (II) that is an additional material selected from metals, woods and other plastics, the composite is suitable for preparing a variety of articles.

### BACKGROUND OF THE INVENTION

Polymers of the ABS type are two-phase plastics comprising

1) a thermoplastic copolymer of resin-forming monomers, e.g. styrene and acrylonitrile, wherein the styrene may be wholly or partially replaced by α-methylstyrene or methyl methacrylate; this copolymer, also known as SAN resin or matrix resin, forms the outer phase;

2) at least one graft polymer, which has been produced by grafting one or more of the monomers listed under 1) onto butadiene homo- or copolymer (“grafting backbone”). This graft polymer (“elastomer phase” or “graft rubber”) forms the disperse phase in the matrix resin.

The ABS polymers 1) and 2) may be produced by known processes, such as emulsion, solution, bulk, suspension or precipitation polymerization, or by a combination of such processes.

If composites are produced by adhesive bonding of these ABS polymers, in particular ABS polymers,in which at least one of the components 1) and 2) has been produced by bulk or solution polymerization processes, adhesive bonding behavior may prove inadequate or undesirable detachment between the adhered layers may occur.

The object of the present invention was therefore to provide composites of an ABS component and at least one further material which do not exhibit such inadequate adhesive bonding behavior.

### DETAILED DESCRIPTION OF THE INVENTION

It has surprisingly been found that this object is achieved using ABS polymers containing defined amounts of sterically hindered amines.

The invention accordingly provides a composite containing

I) an ABS component containing

A) an ABS polymer and

B) 0.05 to 5 wt. %, preferably 0.1 to 4 wt. % and particularly preferably 0.5 to 3 wt. % (relative to I)), of at least one compound containing at least one, preferably at least two, sterically hindered amine groups of the general formula (I)

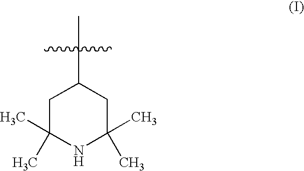

together with

II) at least one further component selected from the group consisting of metals, preferably aluminum or steel, plastics other than ABS, preferably polyvinyl chloride, polyalkylene terephthalate, polycarbonate, polyamide or polyolefins or mixtures thereof, particularly preferably polyethylene and polypropylene and other materials, preferably wood.

ABS Polymers According to A) Contain

A.1) 5 to 100 wt. %, preferably 7.5 to 80 wt. % and particularly preferably 10 to 70 wt. % of at least one graft polymer obtained by solution, suspension or bulk polymerization or 5 to 80 wt. %, preferably 7.5 to 70 wt. % and particularly preferably 10 to 60 wt. % of at least one graft polymer obtained by emulsion polymerization and

A.2) a complementary amount of at least one thermoplastic resin, that is 95 to 0 wt. %, preferably 92.5 to 20 wt. % and particularly preferably 90 to 30 wt. % of at least one thermoplastic resin in the embodiments where the graft polymer is obtained by solution, suspension or bulk polymerization, and 95 to 20 wt. %, preferably 92.5 to 30 wt. % and particularly preferably 90 to 40 wt. % of at least one thermoplastic resin in the embodiments where the graft polymer is obtained by emulsion polymerization.

Graft polymers for the purposes of the invention are those in which monomers or monomer mixtures selected from acrylonitrile, methacrylonitrile, maleic anhydride, N-substituted maleimide, styrene, α-methylstyrene, ring-substituted styrene and methyl methacrylate are graft polymerized onto a rubber (grafting backbone).

Suitable rubbers are virtually all rubbers with glass transition temperatures ≦10° C., preferably those into which butadiene has been incorporated by polymerization. Examples are polybutadiene, styrene-butadiene polymers, acrylonitrile-butadiene polymers, acrylic rubbers, optionally with incorporated structural units derived from butadiene, acrylate rubbers, which contain a cross-linked rubber such as polybutadiene or a copolymer of butadiene with an ethylenically unsaturated monomer such as styrene and/or acrylonitrile as nucleus. Polybutadiene is preferred.

The graft polymers contain from 3 to 95 wt. %, in particular from 5 to 70 wt. %, rubber and from 97 to 5 wt. %, in particular from 95 to 30 wt. %, graft copolymerized monomers. The rubbers are present in these graft polymers in the form of at least partially cross-linked particles of median particle diameter (d₅₀) of 0.05 to 20.0 μm and particularly preferably 0.1 to 0.8 μm, wherein the median particle diameter d₅₀ may be determined by means of ultracentrifuge measurement (c.f. W. Scholtan, H. Lange: Kolloid.-Z. und Z. Polymere 250 (1972), 782-796).

Suitable production processes are emulsion, solution, bulk or suspension polymerization; graft polymers A) which are particularly preferred are those which are produced by emulsion polymerization and/or solution or bulk polymerization.

The thermoplastic polymers A.2) may be obtained from the monomers (graft monomers) graft polymerized onto the rubber or similar monomers, in particular from at least two monomers selected from styrene, α-methylstyrene, p-methylstyrene, halostyrene, acrylonitrile, methacrylonitrile, methyl methacrylate, maleic anhydride, N-substituted maleimides, in particular N-phenyl maleimide, or mixtures thereof.

The preferred thermoplastic resins A.2) are copolymers obtainable from 95 to 50 wt. % styrene, a-methylstyrene or methyl methacrylate or mixtures thereof and 5 to 50 wt. % acrylonitrile, methacrylonitrile, methyl methacrylate or maleic anhydride or mixtures thereof.

Particularly preferred thermoplastic copolymers contain from 20 to 40 wt. % acrylonitrile and 80 to 60 wt. % styrene or α-methylstyrene, incorporated by polymerization. These copolymers are known. They preferably have weight average molecular weights (\overline{M}_{W}) of 15,000 to 200,000 (determined using gel permeation chromatography (GPC)).

The thermoplastic polymers A.2) are preferably produced by solution or bulk polymerization.

Particularly Suitable ABS Polymers A) Contain

A.1.1 5 to 100 wt. % of at least one graft polymer obtained by solution, suspension or bulk polymerization or 5 to 80 wt. % of at least one graft polymer obtained by emulsion polymerization, in each case produced by graft polymerization of

1.1 5 to 97wt. % of a mixture of

1.1.1 5 to 50 wt. % of acrylonitrile, methacrylonitrile, maleic anhydride or N-substituted maleimide or mixtures thereof and

1.1.2 95 to 50 wt. % of styrene, α-methylstyrene, ring-substituted styrene or methyl methacrylate or mixtures thereof onto

1.2 95 to 3 wt. % of at least one rubber having a glass transition temperature T_{G} of <10° C. and

A.1.2 0 to 95 wt. % in the embodiments using a graft copolymer obtained by solution, suspension or bulk polymerization, or 20 to 95 wt. % in the embodiments using a graft polymer obtained by emulsion polymerization, of at least one thermoplastic resin, produced by solution, suspension or bulk polymerization from

2.1 5 to 50 wt. % acrylonitrile, methacrylonitrile, maleic anhydride or N-substituted maleimide or mixtures thereof and

2.2 95 to 50 wt. % styrene, α-methylstyrene, ring-substituted styrene or methyl methacrylate or mixtures thereof.

Compounds with at least one sterically hindered amine groups according to component B) are known or may be produced in a known way. Examples of suitable compounds B) are the compounds known as light stabilizers of the formulae (II) to (IX).

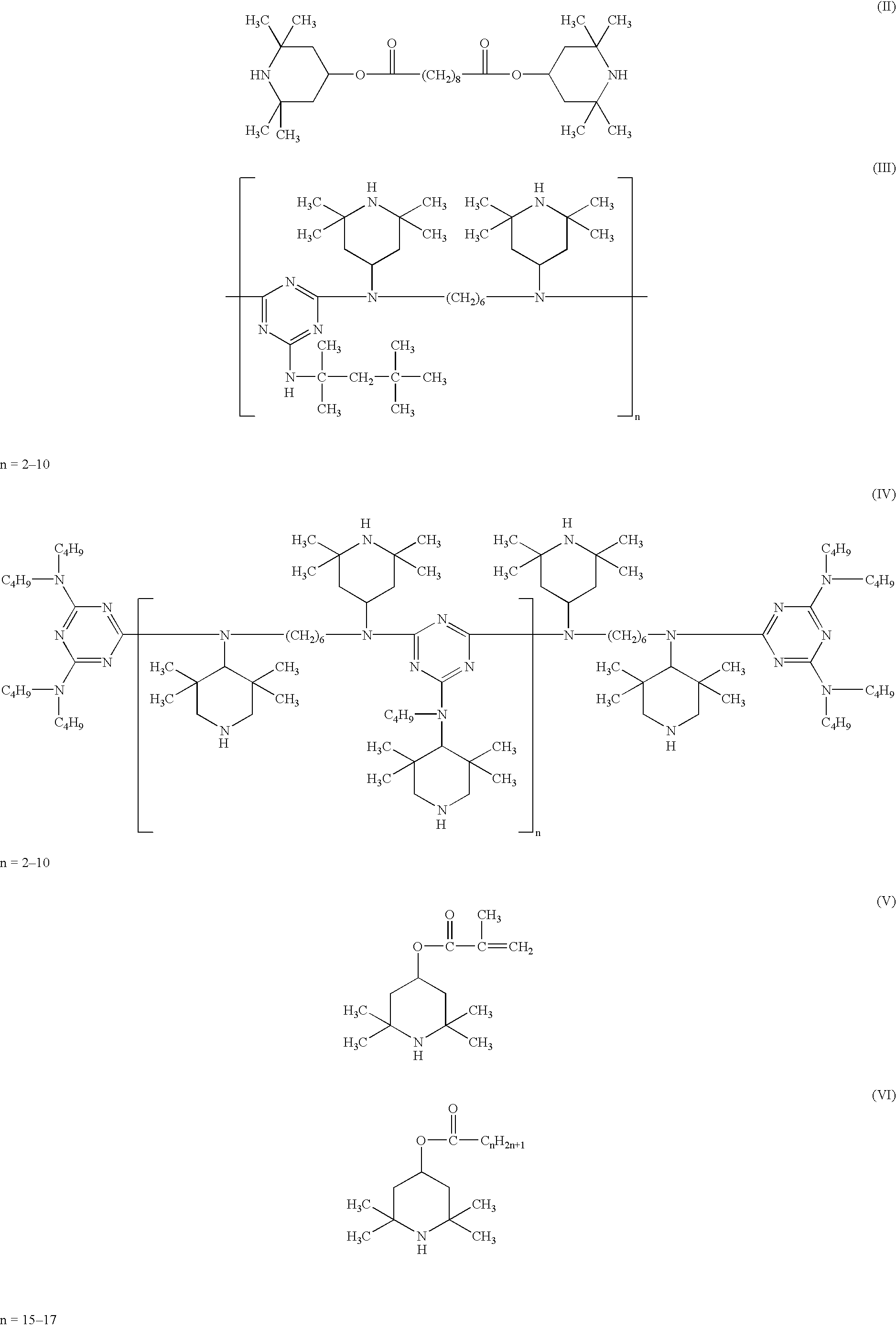

Particular preference is given to the compound of the formula (II), which may be obtained commercially under the trade name Tinuvin® 770.

These compounds are blended with the above-described ABS polymer at elevated temperatures, e.g. 100° to 300° C., in conventional mixing units, kneaders, internal mixers, roll mills, screw compounders or extruders The residence times during the mixing process may vary between 10 seconds and 30 minutes depending on the intensity of the mixing.

In addition, the ABS component may have added to it conventional additives such as pigments, fillers, stabilizers, antistatic agents, lubricants, mold-release agents, flame retardants and the like.

Combining the ABS component with other materials to yield the composites according to the invention is preferably performed by adhesive bonding. The adhesives known to the person skilled in the art for adhesive bonding of composites are suitable for this purpose. Epoxy and acrylate adhesives are particularly preferred.

The composites according to the invention are suitable for producing moulded articles, films and sheets.

Examples of such moulded articles are laminates constructed from two or more layers, e.g. films or sheets consisting of metal and plastics layers.

### EXAMPLES

All quantities stated in parts are parts by weight.

1. Components used

A.1) Graft rubber comprising 50 wt. % polybutadiene with median particle diameter (d₅₀) of 0.35 μm, onto which 36.5 wt. % styrene and 13.5 wt. % acrylonitrile have been graft polymerized in an emulsion.

A.2) Graft rubber comprising 50 wt. % polybutadiene with median particle diameter (d₅₀) of 0.1 μm, onto which 36.5 wt. % styrene and 13.5 wt. % acrylonitrile have been graft polymerized in an emulsion.

A.3) Styrene/acrylonitrile (SAN)=72:28-copolymer with a weight average molecular weight \overline{M}_{W} of approx. 85,000, produced by solution polymerization.

A.4) Styrene/acrylonitrile (SAN)=72:28-copolymer with a weight average molecular weight \overline{M}_{W} of approx. 85,000, produced by emulsion polymerization.

B.1) Tinuvin® 770 (Ciba, Basle, Switzerland)

B.2) Chimassorb® 944 (Ciba, Basle, Switzerland)

C.1) Polyvinyl alcohol (Mowiol® 26-88, Hoechst AG)

C.2) Sodium salt of a resin/acid mixture (sodium salt of Dresinate® 731, Abieta Chemie GmbH, Gersthofen)

C.3) Maleic anhydride.

2. Production and testing of the molding compositions

The parts by weight indicated in Table 1 of the individual polymer components are mixed with the additives likewise indicated in Table 1 together with 0.5 parts by weight of ethylenediamine bisstearylamide in an internal kneader at 200° C. to 230° C. for 3 to 5 minutes and then pelletized.

The pellets are molded at 1 95° C. into approx. 0.5 mm thick sheets. The films cut therefrom are then adhesively bonded on one side to an aluminum sheet (approx. 1 mm) and on the other side to a polyethylene film using a two-component adhesive (Araldite® AW 136 H made by Ciba, Basle, Switzerland, hardener HY 994 made by Ciba, Basle, Switzerland). After adhesive bonding of the sheet/film composite, the latter is cured in the press (load 10 t) at 100° C. for 20 min., whereupon it is cooled to room temperature in the press, the load remaining the same.

Adhesive strength is tested 2 days after curing of the adhesive by manual testing according to the following rating system:

+: composite cannot be separated manually (good adhesion)

0: composite may be partially separated manually (poor adhesion)

−: composite may be easily separated manually (no adhesion).

The evaluation of the adhesive strength test likewise indicated in Table 1 shows that, on adhesive bonding, the ABS polymers according to the present invention exhibit very good adhesion both to metals and to polyolefins

TABLE 1
Compositions of the ABS polymers and test results (adhesive
strength) of the composites produced therefrom.

| | (in parts by weight) | | | | | | | | | |
|---|---|---|---|---|---|---|---|---|---|---|
| | | | | | | | | | | Adhesive |
| | | | | | | | | | | strength on |
| | | | | | | | | | | manual |
| Example | A.1 | A.2 | A.3 | A.4 | B.1 | B.2 | C.1 | C.2 | C.3 | testing |
| 1 | 33.5 | 33.5 | 33 | — | 2 | — | — | — | — | + |
| 2 | 33.5 | 33.5 | 33 | — | — | 1.5 | — | — | — | + |
| 3 (comp.) | 33.5 | 33.5 | 33 | — | — | — | 2 | — | — | − |
| 4 (comp.) | 33.5 | 33.5 | 33 | — | — | — | — | 2 | — | − |
| 5 (comp.) | 33.5 | 33.5 | 33 | — | — | — | — | — | 2 | 0 |
| 6 (comp.) | 33.5 | 33.5 | 33 | — | — | — | — | — | — | − |
| 7 (comp.) | 33.5 | 33.5 | — | 33 | — | — | — | — | — | 0 |
| 8 | 33.5 | 33.5 | — | 33 | 1.5 | — | — | — | — | + |

Although the invention has been described in detail in the foregoing for the purpose of illustration, it is to be understood that such detail is solely for that purpose and that variations can be made therein by those skilled in the art without departing from the spirit and scope of the invention except as it may be limited by the claims.

What is claimed is:

1. A composites comprising
I) an ABS component containing
A) an ABS polymer and
B) 0.05 to 5 wt. %, relative to I), of at least one compound containing at least one sterically hindered amine groups of the general formula (I) 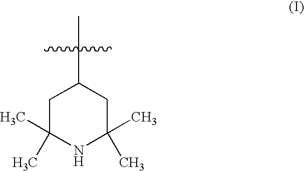
and
II) at least one additional component selected from the group consisting of metal, wood and plastics other than (I).

2. The composite according to claim 1, in which the ABS polymer A) contains
1. 5 to 100 wt. % of at least one graft copolymer obtained by solution, suspension or bulk polymerization or 5 to 80 wt. % of at least one graft copolymer obtained by emulsion polymerization, said graft, both occurrences, being the polymerization product of
1.1 5 to 97 wt. % of a mixture of
1.1.1 5 to 50% relative to the weight of the mixture of at least one member selected from the group consisting of acrylonitrile, methacrylonitrile, maleic anhydride and N-substituted maleimide, and
1.1.2 95 to 50% relative to the weight of the mixture of at least one member selected from the group consisting of styrene, α-methylstyrene, ring-substituted styrene and methyl methacrylate, grafted onto
1.2 95 to 3 wt. % of at least one rubber having a glass transition temperature T_{G} of <10° C., and
2. at least one thermoplastic resin, produced by solution, suspension or bulk polymerization from
2.1 5 to 50% relative to the total weight of 2.1 and 2.1 of at least one member selected from the group consisting of acrylonitrile, methacrylonitrile, maleic anhydride and N-substituted maleimide, and
2.2 95 to 50% relative to the total weight of 2.1 and 2.1 of at least one member selected from the group consisting of styrene, α-methylstyrene, ring-substituted styrene and methyl methacrylate, with the provisos that (i) in the embodiments where said graft copolymer is obtained by solution, suspension or bulk polymerization, said 2 is present in an amount of 0 to 95% relative to the weight of said ABS polymer and that (ii) in the embodiments where said graft copolymer is obtained by emulsion polymerization, said 2 is present in an amount of 20 to 95% relative to the weight of said ABS polymer.

3. The composite according to claim 1, in which the said B conforms structurally to

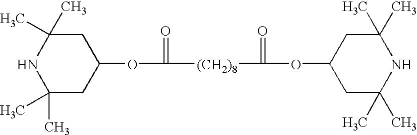

4. The composite according to claim 1, in which said additional component is a member selected from the group consisting of aluminum, steel, polyvinyl chloride, polyethylene terephthalate, polybutylene terephthalate, polycarbonate, polyamide, polyethylene, polypropylene and wood.

5. The composite according to claim 1, in which the ABS component is adhesively bonded to additional component.

6. The composite according to claim 5, in which the adhesive bonding is by epoxy adhesive or acrylate adhesive.

7. A method of using an ABS component comprising
A) an ABS polymer and
B) 0.05 to 5%, relative to the weight of A), of at least one compound containing at least one sterically hindered amine group of the general formula (I) 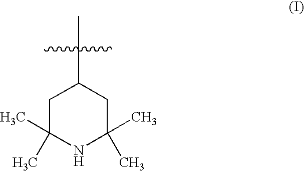
comprising producing a composite.

8. A method of using the composite according to claim 1 comprising producing a molded article.

9. The Molded article produced by the method of claim 8.
